(19) United States
(12) Patent Application Publication
(10) Pub. No.: US 2004/0078584 A1
(43) Pub. Date: Apr. 22, 2004

(54) Interchip transport bus copy protection

(75) Inventors: Paul Moroney, Olivenhain, CA (US); Eric J. Sprunk, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: GENERAL INSTRUMENT CORP., Horsham, PA

(21) Appl. No.: 10/647,064

(22) Filed: Aug. 22, 2003

Related U.S. Application Data
(60) Provisional application No. 60/405,537, filed on Aug. 23, 2002.

(51) Int. Cl. G06F 12/14

(52) U.S. Cl. 713/189

(57) ABSTRACT

According to the invention, a content processing unit for protecting interchip content pathways transporting digital content objects is disclosed. The content processing unit includes a first chip package, a second chip package and a content pathway. The first chip package includes a first body, a first plurality of interconnects, an encryption engine, and a first key storage register capable of storing a first key, and the second chip package includes a second body, a second plurality of interconnects, an encryption engine, and a second key storage register capable of storing a second key. The first key is used by the encryption engine to produce ciphertext content and cannot be overwritten after a programmability period. The first and second key storage registers are non-readable from outside the first body. The second key is used by the decryption engine to produce plaintext content from the ciphertext content. The content pathway couples a first subset of the first plurality and a second subset of the second plurality. The content pathway transports the digital content objects as the ciphertext content.

This application claims the benefit of and is non-provisional of U.S. Provisional Application Serial No. 60/405,537 filed on Aug. 23, 2002, which is incorporated by reference in its entirety.

### BACKGROUND OF THE INVENTION

This invention relates in general to content protection and, more specifically, to interchip transport bus copy protection methods and apparatuses.

Content owners are concerned about protecting their content when in digital form. Digital copies of content preserve their quality through subsequent copying, unlike analog copies. Digital content is available through terrestrial broadcast, digital cable, satellite, and the Internet. In some cases, the digital content is protected during transport, but in other times it is not. For example, digital cable uses conditional access technology to protect video programs during transport, but terrestrial broadcast television has no encryption of the video programs.

Any scheme to protect digital content is as vulnerable as its least protected component. Today, transport to the content receiver is often protected. For example, satellite and cable television systems encrypt the signal delivered to a set top box. Due to the intense focus on digital copy protection, digital interfaces between the set top box and other (A/V) equipment in the home increasingly has mandated protection with encryption; for example, an IEEE-1394 interface must use 5C encryption and copy management, and a Digital Visual Interface (DVI) interface must use High Definition Copy Protection (HDCP) encryption and copy management. While these complex protection schemes can protect communication between A/V sources and sinks in the home, there are paths inside the set top box and these other products that are themselves not protected. Content owners are increasingly concerned with the risks these internal paths present as well.

### BRIEF DESCRIPTION OF THE DRAWINGS

The present invention is described in conjunction with the appended figures:

FIG. 1A is a block diagram of an embodiment of a content protection scheme having a set top box with an IEEE-1394 interface and a DVI interface;

FIG. 1B is a block diagram of another embodiment of the content protection scheme having a set top box with internal program storage;

FIG. 1C is a block diagram of yet another embodiment of the content protection scheme having a set top box with key relay capability;

FIG. 2A is a flow diagram of an embodiment of a process for loading interchip keys into the set top box;

FIG. 2B is a flow diagram of another embodiment of a process for loading interchip keys into the set top box having device key encryption key capability;

FIG. 3A is a flow diagram of an embodiment of a process for repairing a set top box; and

FIG. 3B is a flow diagram of an embodiment of a process for repairing a set top box with a key relay capability.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

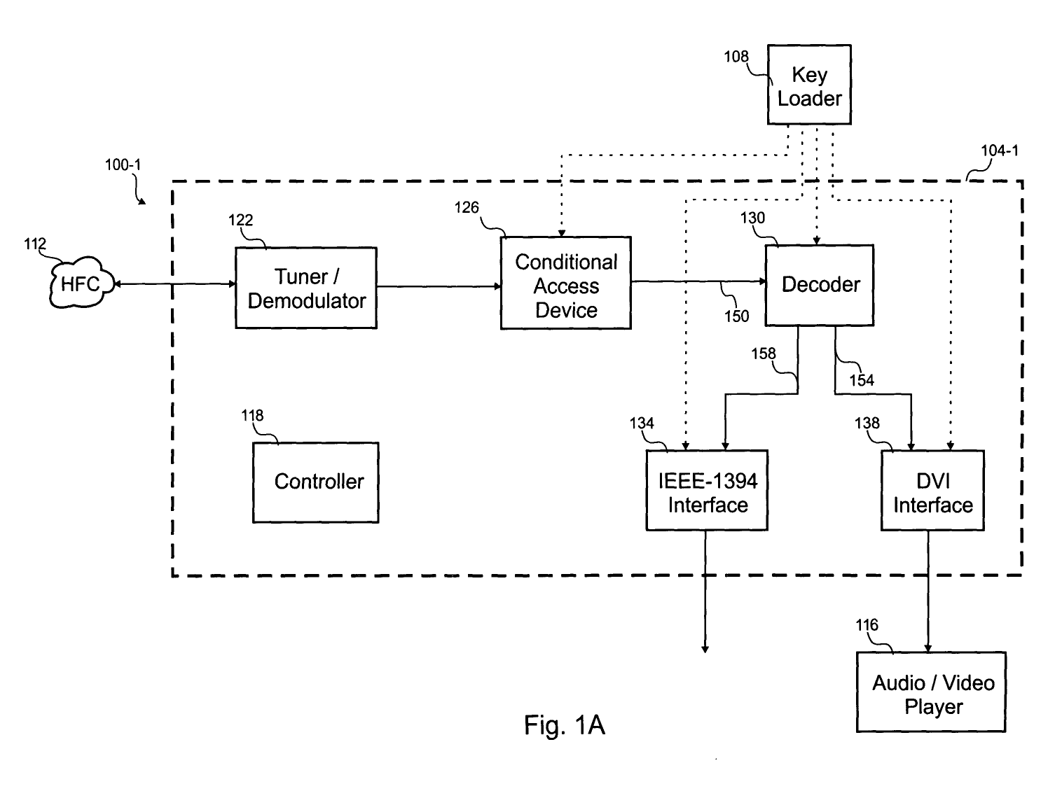

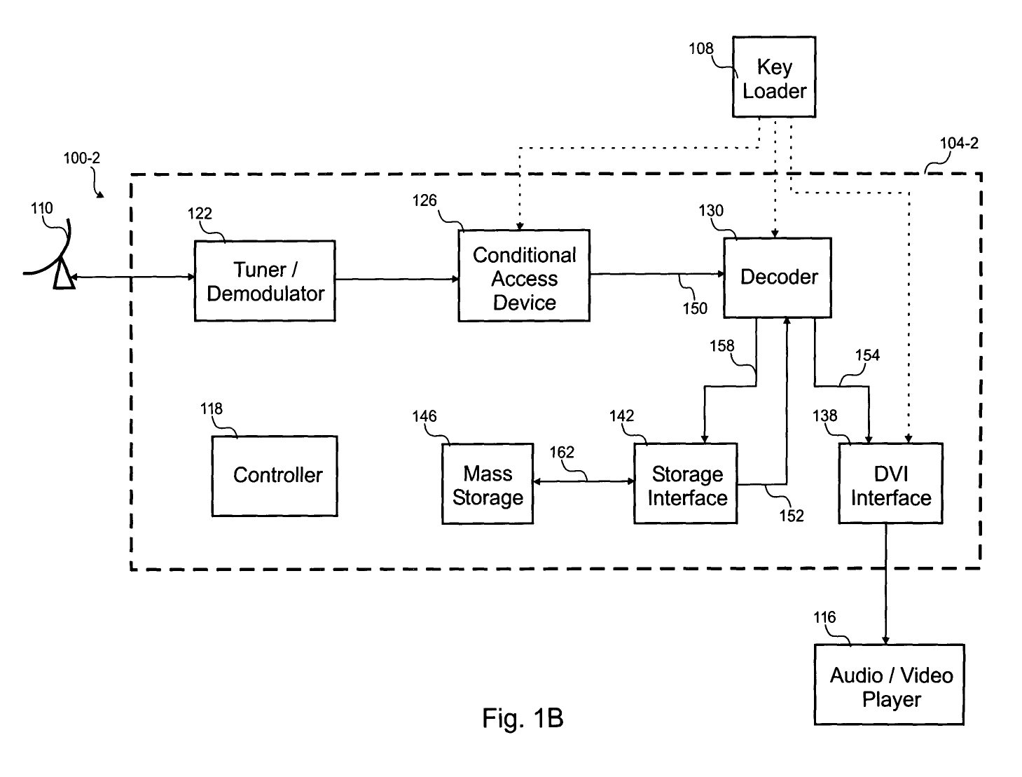

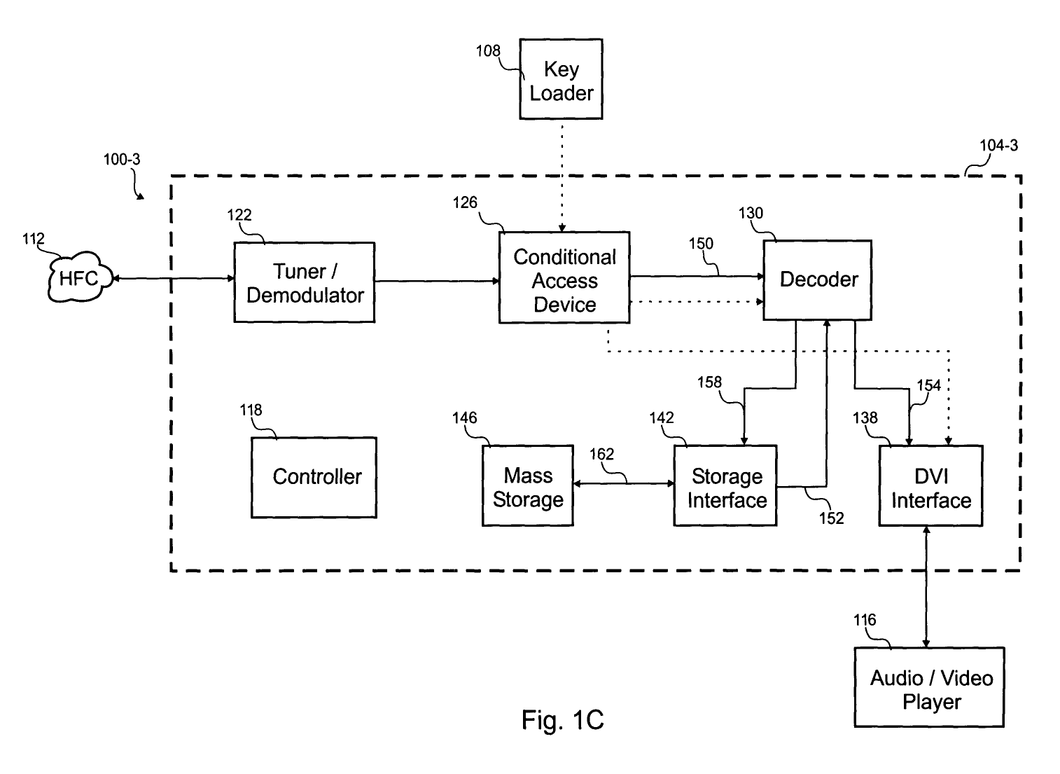

Referring first to FIG. 1A, a block diagram of an embodiment of a content protection scheme 100-1 having a set top box 104-1 with a IEEE-1394 interface 134 is shown. Included in the content protection scheme 100-1 are the set top box 104-1, a hybrid fiber-coaxial (HFC) network 112, and an audio/video (A/V) player 116. Content and control information passes over the HFC network 112 to the set top box 104. Other embodiments could receive the content in any manner, for example, from a network, a satellite link, the Internet, a computer port, a wireless link, etc. Although not shown, the controller 118 manages the various blocks within the set top box 104-1. In various embodiments, the set top box 104 could be integral or partially integral with the A/V player 116 or some other piece of A/V equipment. Also shown in this diagram is a key loader 108, typically connected to the set top box only in the factory environment, or in some other environment prior to the set box arrival in the consumer's home. The content processed in the set top box 104 may be compressed or non-compressed.

This embodiment receives a content stream from the HFC network 112, processes that stream and produces a digital stream in IEEE-1394 or DVI format. The IEEE-1394 format could pass the content stream to other A/V equipment and the DVI format passes the content stream to the A/V player 116 or television. Some embodiments could use a computer display, projector, speakers, headphones, etc. as the A/V player 116.

Under the direction of the controller 118, the content stream from the HFC network 112 is processed. The tuner/demodulator 122 turns a frequency-multiplexed channel from a fiber or coaxial cable into a digital bitstream. The channel could carry a number of compressed encrypted digital programs multiplexed into the digital bitstream, but separated in some manner. In the typical case of MPEG compression and transport, MPEG compressed video and audio forms a single program, which is carried in MPEG transport packets, and encrypted, and multiple programs are multiplexed into an MPEG-2 transport stream, all separated by various PIDs. Not all set top boxes 104 are authorized to process any given program. Authorization is checked in the conditional access device (or subsystem), and authorized content is decrypted. Typically, the conditional access device includes a processor. Programs that are authorized and decrypted pass as transport streams to the decoder 130 for decompression and possible conversion into any number of digital formats. This embodiment of the decoder 130 supports the DVI format for interface 138. The set top box 1394 interface 134 is designed to carry transport streams directly, or other content formats. These flows can route from the decoder 130 or in some cases directly from the conditional access device.

The key loader 108 is used to load keys into some of the various blocks which use cryptography. The keys could be loaded in a secure factory environment, or in a less secure factory environment using key encrypting keys. The key encrypting keys could use symmetric or asymmetric algorithms. Keys could also be loaded in some other warehouse or staging location, prior to the set top box shipment to the consumer. The conditional access device 126 decrypts an authorized program. To avoid sending unprotected content to the decoder (or other internal node), keys are used by the conditional access device 126 to encrypt a first datalink 150 to the decoder 130. This embodiment uses a 128 bit AES key for the first datalink 150, but other algorithms and key sizes could be used. A second datalink 154 between the decoder 130 and the DVI interface 138 is also protected with cryptography. Similarly, a third datalink 158 between the decoder 130 (or possibly the conditional access device) and the IEEE-1394 interface 134 use cryptography to protect the data. Additionally, the IEEE-1394 and DVI interfaces 134, 138 follow the 5C and HDCP standards, respectively, to protect their datastreams that travel outside the set top box 104-1. Higher level keys and certificates are required to support these standards. All the keys can be delivered with the key loader 108.

Cryptographic interchip keys are used to protect the various datalinks. The conditional access device 126 is a single chip package in this embodiment. Other embodiments would have multiple chips in a single package or module. Interchip keys for the first datalink 150 and any keys for conditional access functions are stored in the conditional access device 126. This embodiment has a battery to retain the keys in the conditional access device 126, but other non-volatile memory types could be used, for example, flash RAM, SRAM, MRAM, EPROM, EEPROM, magnetic core memory, etc. Once the interchip key for the first datalink 150 is written, it cannot be read out from outside the chip package for the conditional access device 126. Further, the ability to write again to the interchip key register for the first datalink 150 can be disabled in this embodiment. A fusable link or fuse is programmed after writing the interchip key to prevent further writes. As an example, a pin on the chip package could be used to serially load the interchip key register. After loading, a large voltage is applied to that pin to bum a fuse between the pin the interchip key register. Other embodiments could use windowless EPROM, PROM, a non-erasable gating signal, etc. to prevent further writes to the interchip key register. A fusable link or fuse based PROM can only change each bit's state once or not at all. Programming these PROMS entails creating shorts or blowing fuses to indicate one bit state or another.

Interchip keys are also stored in the decoder 130, the IEEE-1394 interface 134 and the DVI interface 138 in a manner that prevents the interchip key register from being read from outside the chip package. These interchip keys are also battery backed-up in this embodiment, but other methods could be used to retain the interchip keys during a power cycle as discussed above. In this embodiment, the interchip key register can be overwritten in the decoder 130, the IEEE-1394 interface 134 and the DVI interface 138, but not in the conditional access device 126. If the interchip key register in the decoder 130, the IEEE-1394 interface 134 and the DVI interface 138 is overwritten by a hacker, the set top box would not be operable because the interchip key in the conditional access device 126 cannot be overwritten and thus content flows would remain encrypted and unusable.

Further, the interchip keys for the first, second and third datalinks 150, 154, 158 are the same or algorithmically related in this embodiment. For example, the decoder 130 receives from the first datalink 150 ciphertext encrypted with a first interchip key. The ciphertext is decrypted and decompressed and possibly further processed. The decompressed and processed content is then encrypted with the first interchip key for the second datalink 154. This could continue for successive datalinks indefinitely. So long as the first point of a datalink in a serial chain of datalinks used an interchip key that could not be overwritten, the other points in the successive datalinks could tolerate key registers that could be overwritable, and maintain security. This may allow those other devices to be less expensive. Alternatively, it may be prudent to have all key registers write-once, so that hackers could not even attempt to modify them, and thus render the set top box useless.

If an interchip key to encrypt or decrypt a datalink is altered, the chain of datastreams would break down and prevent propagation of data from that point on. For example, the first and second datalinks 150, 154 could use the same first interchip key. The conditional access device 126 would encrypt with the first interchip key from an interchip key register that could not be altered. The decoder 130 would decrypt with the first interchip key. The decoder 130 would also encrypt with the first interchip key. If a hacker overwrote the interchip key register in the DVI interface 138 that held the first interchip key for decrypting the second datalink 154, the second datalink 154 could not be deciphered by the DVI interface 138. If the hacker overwrote the interchip key register holding the first interchip key in the decoder 130 also, the second datalink 154 could become operable, but the first datalink 150 would become inoperable and thus the second link could not forward any content.

The interchip keys used for the successive datalinks in a serial chain of datalinks could be different, but related. A first interchip key could be used for the first datalink 150. The second datalink 154 could use a second interchip key that is derivable from the first interchip key. For example, the second interchip key could be the first interchip key encrypted with a third key.

The above embodiments use a single key for a datalink. Some embodiments could use different keys for each datalink end point such that a given datalink could have multiple programs protected with different keys. For example, there are two eventual end points within this embodiment of the set top box 104-1. More specifically, the programs can leave the set top box 104-1 through either an IEEE-1394 port or a DVI port. The conditional access device 126 could differentiate the encryption based upon which end point is intended. A first interchip key could be used for the path of one program to the IEEE-1394 port and a second interchip key could be used for the path of a second program to the DVI port. The first datapath 150 logically separates these paths by use of different keys and the PIDs that correspond to the different programs in the transport multiplex, for the case of MPEG-2 transport flows.

With reference to FIG. 1B, a block diagram of another embodiment of the content protection scheme 100-2 having a set top box 104-2 with internal program storage is shown. This embodiment uses a storage interface 142 to connect to a mass storage device 146 that can store compressed programs for later playback over link 152. While it is typical for set top boxes with internal mass storage to store compressed content in encrypted form, the keys used are often not protected. The concepts described above of write only registers linked to the conditional access device can be used to store and protect these keys. Since encrypt and decrypt for this stored data is performed in the decoder, only one register is required; in fact, the key or keys can and should be derived from the register already present in that decoder for the other links 150 and 154.

Referring next to FIG. 1C, a block diagram of yet another embodiment of the content protection scheme 100-3 having a set top box 104-3 with a key relay capability is shown. This embodiment stores the programs in the mass storage device 146 in encrypted form, encrypted in the decoder 130.

The key relay capability allows the conditional access device 126 to receive or even generate on command from the loader interchip keys and key encryption keys for the various other chip packages. In its simplest form, when the relay capability is activated under a protected command from the key loader, the conditional access device 126 sends the interchip keys out to the target devices. In this version, the conditional access device serves as a relay for the key loader, relaying keys while in the factory or similar environment. Such a relay would not function once set top boxes are delivered to the home, where there is no key loader. In alternative embodiments, any device in the set top box can function as a relay agent for the key loader, so long as it has connectivity to all the required devices, and it can be disabled once its task is complete.

In an alternative embodiment, an even more secure relay can be supported. In this approach, when activated as before, the conditional access device 126 sends the interchip keys encrypted in the appropriate “key encryption key” for the target chip package. For example, the conditional access device 126 would send the same interchip key to the decoder 130 and the DVI interface 138 chip packages. Each transmission of the interchip key is uniquely encrypted with the key encryption key for that chip package, that is, that device type. Each chip package type could have a unique key encryption key or some or all types could share a key encryption key. The key encryption key could be symmetric or asymmetric. In some embodiments, the key loader could pass the interchip key already encrypted for each key encrypting key to the conditional access device 126 for later distribution without a separate encrypting step.

The key encrypting keys are not readable from outside the chip packages. The key encrypting keys for each chip package would be hard-wired into the chip package. The hard wired key encrypting keys could be the same for all functionally-equivalent chip packages or could differ for each new device type A unique identifier on the chip package could be used to query a database for the unique key encrypting key. In this embodiment, all functionally-equivalent chip packages use the same key encrypting key. In an alternative embodiment, it is possible for the key loader to load keys directly to each device without use of a relay, but still encrypted under key encryption keys.

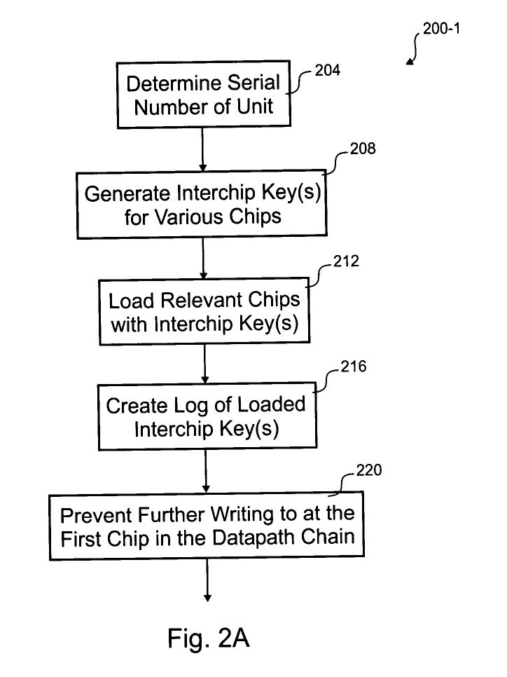

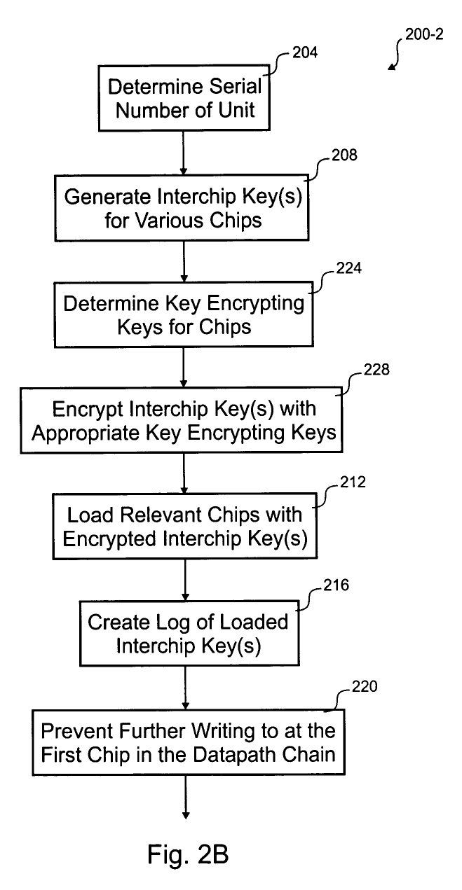

With reference to FIG. 2A, a flow diagram of an embodiment of a process 200-1 for loading interchip keys into the set top box 104 is shown. This embodiment uses unique interchip keys for each set top box 104. The depicted portion of the process 200-1 begins in step 204 where the serial number of the set top box 104 is determined. This could be determined by reading a bar code or printing a label with the serial number. In some cases the chip packages receiving keys could also be serialized and tracked. The keys are generated in step 208 based upon the configuration of the set top box 104, number of keys and type of key algorithms used for the configuration. Generation of keys could be done elsewhere and transported to the set top box 104. In this embodiment, keys are generated for each set top box 104 and securely transferred to the production line manufacturing the set top boxes 104.

The generated keys are sent by the key loader 108 to the set top box 104 in step 212. Each chip is loaded separately by the key loader 108 in this embodiment. Some embodiments could load a first chip that relays the key to the other chips. If the keys are distributed by the first chip to the others in plain text form, this feature is disabled before the set top box is shipped to the consumer. The keys loaded are logged in step 216 and indexed by serial number of the set top box 104. This log of keys can be accessed during repair to reload the keys into erased key registers or replacement chips. Before release to the field, the ability to write keys to at least the first chip in any datapath chain is disabled in step 220, for example, a fuse is blown for the key load pin of the conditional access device 126 in one embodiment. This can be performed immediately after writing the keys or at some other point before the set top box is exposed to possible attack by hackers and content pirates.

Referring next to FIG. 2B, a flow diagram of another embodiment of a process 200-2 for loading interchip keys into the set top box 104 having device key encryption keys is shown. In this embodiment, the key loader 108 encrypts the interchip keys in the appropriate key encrypting key and loads the encrypted interchip keys either directly to these devices, or into the conditional access device 126 for subsequent relay. Other embodiments could allow the conditional access device 126 to perform encryption of the interchip keys. Where the conditional access device 126 performs the encryption, the interchip keys and key encryption keys are stored within the chip package of the conditional access device 126. In contrast, where the interchip keys are encrypted at the key loader, the key encryption keys are not stored internal to the conditional access chip 126.

The depicted portion of the process 200-2 begins in step 204 where the serial number of the set top box 104 is determined. The interchip keys are uniquely generated in step 208 for this particular set top box 104. This embodiment uses a single key for all interchip datapaths. Other embodiments could have a different key for each interchip datapath or could have a different key for each endpoint port out of the set top box 104. Each chip connected to an interchip datapath in this embodiment has a key encrypting key unique to that chip or the manufacturer for that chip. The key encrypting keys are determined in step 224 via database lookup.

The interchip key is encrypted in step 228 under each key encrypting key by the key loader 108. Those encrypted interchip keys are loaded into their respective chips in step 212. Each chip would decrypt the ciphertext interchip key with the key encrypting key known to that chip to reveal the plaintext interchip key. As mentioned above, some embodiments would have the encrypted interchip keys loaded into the conditional access device for relay to the specific devices, rather than be directly loaded. A log of the interchip keys is updated in step 216 to reflect the keying for this particular set top box 104. The conditional access device 126 is prevented from accepting other interchip keys in step 220.

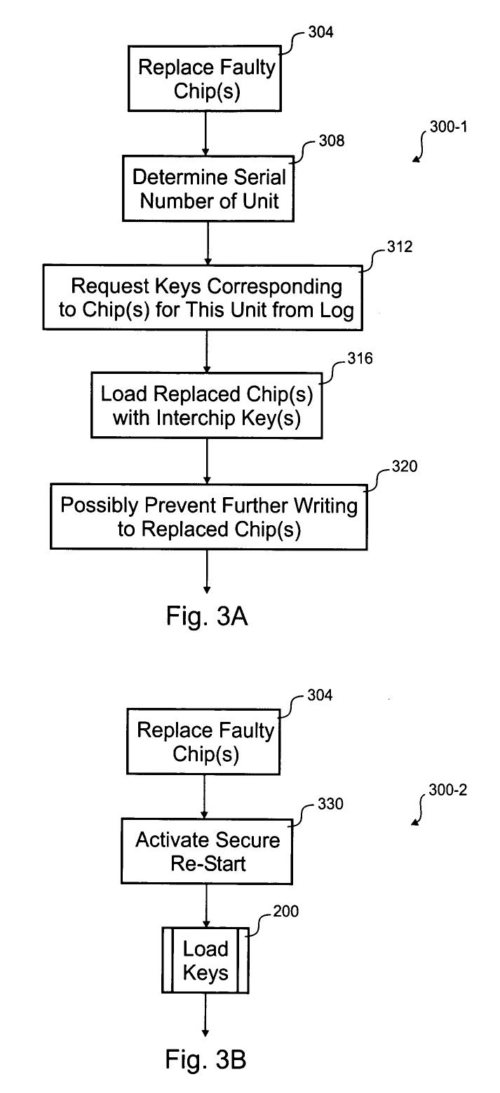

With reference to FIG. 3A, a flow diagram of an embodiment of a process 300-1 for repairing a set top box 104 is shown. In the case of a repair where the conditional access device is replaced, repair can proceed as depicted in FIGS. 2A or 2B. However, if the conditional access device is not replaced, but the decoder or 1394 or DVI or similar device is replaced, its replacement needs the key to be written. The depicted portion of this process begins in step 304 where the faulty chips as mentioned are repaired or replaced. In step 308, the serial number for the set top box 104 is determined. The serial number could be electronically stored and read or manually read from a label on the set top box 104. A connection is made to the log that recorded the unique keys originally loaded into this particular set top box 104 in step 312 to retrieve the interchip key(s). The log could be electronically accessible by the repair facility.

The retrieved keys are loaded into the set top box 104 in step 316. Where the interchip keys are encrypted, the key encrypting keys could be looked up as well in step 312. The encryption could be done in the key loader 108 or remote to the repair facility in a more secure facility. In step 320, repaired chips could be programmed to not allow further writing of the interchip key register(s), if that is possible.

Referring next to FIG. 3B, a flow diagram of an alternative embodiment of a process 300-2 for repairing a set top box 104 is shown. Even though the conditional access device 126 was described earlier to store the interchip key(s) in write only, write once register(s), it can instead be designed to start the whole process over again if commanded securely to do so by the key loader. Thus first set top boxes are repaired by replacing faulty devices, as in step 304. Second, the key loader would need to access the proper secure commands to activate the re-start process of step 330. Third, after activation, interchip keys could be established in step 200 as described in FIGS. 2A and 2B.

In many alternative embodiments, the conditional access function is performed in a smart card or in a removable module such as CABLELABS'™ CABLECARD™ or DVB's™ common interface module. In such a case, the conditional access module cannot serve the function described in this invention. For the case of the smart card, the device in the set top box that performs conditional access decryption needs to take on the role of anchoring the protection, including the write-only, write-once, key register(s) and interchip encryption. In the case of transport processing modules such as the CABLELABS'™ CABLECARD™, conditional access decryption is performed in the module itself, and the content flows return to the set top box encrypted under a copy protection key. The device that receives this flow and decrypts under the copy protection key is the device to anchor the protection of this invention, with the write only, write once register and interchip encryption.

A number of variations and modifications of the invention can also be used. For example, the above embodiments are discussed in the context of a set top box, but any content receiver processing digital content could use interchip datapath protection. The content receiver could be a digital music player, a digital video recorder, A/V equipment, a computer, a digital movie projector, etc.

While the principles of the invention have been described above in connection with specific apparatuses and methods, it is to be clearly understood that this description is made only by way of example and not as limitation on the scope of the invention.

What is claimed is:

1. A content processing unit for protecting interchip content pathways transporting digital content objects, the content processing unit comprising:
a first chip package, wherein the first chip package comprises:
a first body,
a first plurality of interconnects,
an encryption engine, and
a first key storage register capable of storing a first key, wherein:
the first key is used by the encryption engine to produce ciphertext content,
the first key storage register is non-readable from outside the first body, and
the first key storage register cannot be overwritten after a programmability period;
a second chip package, wherein the second chip package comprises:
a second body,
a second plurality of interconnects,
a decryption engine, and
a second key storage register capable of storing a second key, wherein:
the second key is used by the decryption engine to produce plaintext content from the ciphertext content, and
the second key storage register is non-readable from outside the second body;
a content pathway coupling a first subset of the first plurality and a second subset of the second plurality, wherein the content pathway transports the digital content objects as the ciphertext content.

2. The content processing unit for protecting interchip content pathways transporting digital content objects as recited in claim 1, wherein the programmability period ends when a command is sent to the first plurality.

3. The content processing unit for protecting interchip content pathways transporting digital content objects as recited in claim 2, wherein the command activates a fusable link.

4. The content processing unit for protecting interchip content pathways transporting digital content objects as recited in claim 1, wherein the programmability period ends after writing to the first key storage register.

5. The content processing unit for protecting interchip content pathways transporting digital content objects as recited in claim 1, wherein:
the content processing unit is a set top box, and
the first chip package is a conditional access chip.

6. The content processing unit for protecting interchip content pathways transporting digital content objects as recited in claim 1, wherein at least one of the first and second chip packages comprises a plurality of semiconductor substrates.

7. The content processing unit for protecting interchip content pathways transporting digital content objects as recited in claim 1, wherein:
at least one of the first and second chip packages further comprises a key encryption key, and
at least one of the first and second keys is protected with the key encryption key outside the first body.

8. The content processing unit for protecting interchip content pathways transporting digital content objects as recited in claim 1, wherein the second key storage register is overwritable by manipulating the second plurality.

9. The content processing unit for protecting interchip content pathways transporting digital content objects as recited in claim 1, wherein:
the second chip package further comprises a second encryption engine, and
the second encryption engine uses the second key or another key that is a function of the second key to encrypt the content object or a derivative thereof.

10. The content processing unit for protecting interchip content pathways transporting digital content objects as recited in claim 9, further comprising a third chip package comprising a third key that can decrypt ciphertext produced with the second encryption engine.

11. The content processing unit for protecting interchip content pathways transporting digital content objects as recited in claim 1, wherein:
the content processing unit is part of a larger system comprising a third plurality of functionally equivalent content processing units, and
each of the third plurality uses a different first key to protect their respective content pathways.

12. The content processing unit for protecting interchip content pathways transporting digital content objects as recited in claim 1, wherein the digital content objects are either compressed or non-compressed.

13. A method for protecting interchip content pathways transporting digital content objects within a content processing unit, the method comprising steps of:
loading a first key into a first key storage register in a first chip package, wherein the first key in the first key storage register is non-readable from outside the first chip package;
activating a feature of the first chip package that prevents overwriting the first key in the first key storage register from outside the first chip package;
encrypting digital content with the first key to produce ciphertext content;
coupling the ciphertext content from the first chip package to a content pathway;
loading a second key into a second key storage register in a second chip package, wherein the second key in the second key storage register is non-readable from outside the second chip package;
coupling the ciphertext content from the content pathway to a second chip package; and
decrypting the ciphertext content with the second key to reformulate the digital content.

14. The method for protecting interchip content pathways transporting digital content objects within the content processing unit as recited in claim 13, further comprising steps of:
providing a key encryption key in the at least one of the first and second chip packages; and
decrypting at least one of the first and second keys with the key encryption key, whereby the at least one of the first and second keys is protected with the key encryption key outside the first chip package.

15. The method for protecting interchip content pathways transporting digital content objects within the content processing unit as recited in claim 13, further comprising a step of overwriting the second key in the second key storage register from outside the second chip package.

16. The method for protecting interchip content pathways transporting digital content objects within the content processing unit as recited in claim 13, further comprising steps of:
encrypting the digital content or a derivative thereof in the second chip package to produce second ciphertext content using the second key or another key that is a function of the second key,
coupling the second ciphertext content to a second content pathway.

17. The method for protecting interchip content pathways transporting digital content objects within the content processing unit as recited in claim 16, further comprising steps of:
coupling the second ciphertext content from the second content pathway to a third chip package; and
decrypting the second ciphertext content with the third key to reformulate the digital content.

18. The method for protecting interchip content pathways transporting digital content objects within the content processing unit as recited in claim 13, wherein:
the content processing unit is part of a larger system comprising a plurality of functionally equivalent content processing units, and
each of the plurality uses a different first key to protect their respective content pathways.

19. The method for protecting interchip content pathways transporting digital content objects within the content processing unit as recited in claim 13, further comprising steps of:
replacing at least one of the first and second chip packages;
querying a database for at least one of the first and second keys; and
loading at least one first and second keys into its respective chip package.

20. The method for protecting interchip content pathways transporting digital content objects within the content processing unit as recited in claim 13, further comprising steps of:
replacing at least one of the first and second chip packages; and
activating a secure re-start feature to load at least one of the first and second keys into its respective chip package from another chip package.

21. A computer system adapted to perform the computer-implementable method for protecting interchip content pathways transporting digital content objects within the content processing unit of claim 13.

22. A computer-readable medium having computer-executable instructions for performing the computer-implementable method for protecting interchip content pathways transporting digital content objects within the content processing unit of claim 13.

23. A content processing unit for protecting interchip content pathways transporting digital content objects, the content processing unit comprising:
a first chip package, wherein the first chip package comprises:
a first body,
a first plurality of interconnects,
an encryption engine, and
a first key storage register capable of storing a first key, wherein:
the first key is used by the encryption engine to produce ciphertext content,
the first key storage register is non-readable from the first plurality of interconnects, and
the first key storage register cannot be overwritten after being written once;
a second chip package, wherein the second chip package comprises:
a second body,
a second plurality of interconnects,
a decryption engine, and
a second key storage register capable of storing a second key, wherein:
the second key is used by the decryption engine to produce plaintext content from the ciphertext content, and
the second key storage register is non-readable from the second plurality of interconnects;
a content pathway coupling a first subset of the first plurality and a second subset of the second plurality, wherein the content pathway transports the digital content objects as the ciphertext content.

24. The content processing unit for protecting interchip content pathways transporting digital content objects as recited in claim 23, wherein:
the first key storage register has a third plurality of bits, and
each of the third plurality can only change its stored value, at most, one time.

25. The content processing unit for protecting interchip content pathways transporting digital content objects as recited in claim 23, wherein:
at least one of the first and second chip packages further comprises a key encryption key, and
at least one of the first and second keys is protected with the key encryption key outside the first body.

26. The content processing unit for protecting interchip content pathways transporting digital content objects as recited in claim 23, wherein the second key storage register is overwritable from outside the second chip package.

27. The content processing unit for protecting interchip content pathways transporting digital content objects as recited in claim 23, wherein:
the second chip package further comprises a second encryption engine, and
the second encryption engine uses the second key or another key that is a function of the second key to encrypt the content object or a derivative thereof.

28. The content processing unit for protecting interchip content pathways transporting digital content objects as recited in claim 27, further comprising a third chip package comprising a third key that can decrypt ciphertext produced with the second encryption engine.

29. The content processing unit for protecting interchip content pathways transporting digital content objects as recited in claim 23, wherein:
the content processing unit is part of a larger system comprising a third plurality of functionally equivalent content processing units, and
each of the third plurality uses a different first key to protect their respective content pathways.
